(19) United States
(12) Patent Application Publication
(10) Pub. No.: US 2016/0368195 A1
(43) Pub. Date: Dec. 22, 2016

(54) Suction Channel for an Extractor Device for Conveying Cut Waste Strips of a Film Web

(71) Applicant: Windmoller & Holscher KG, Lengerich (DE)

(72) Inventors: Fabian Sundermann, Osnabruck (DE); Frank Hoffman, Greven (DE); Thomas Sehlleier, Coesfeld (DE)

(21) Appl. No.: 15/121,621

(22) PCT Filed: Feb. 25, 2015
(86) PCT No.: PCT/EP2015/053887

§ 371 Date: Aug. 25, 2016

(30) Foreign Application Priority Data
Feb. 27, 2014 (DE) 10 2014 102 610.1

(51) Int. Cl. B29C 47/08; B29B 17/00

(52) U.S. Cl. CPC B29C 47/0894; B29B 17/0005; B29L 2007/008

(57) ABSTRACT

The present invention relates to a suction channel (10) for a suction device (100) for conveying of cut waste strips (210) of a film web (200) transverse to the conveyance direction (F) of the film web (200) comprising a first channel portion (20) and a second channel portion (30) separated from the first channel portion (20) by at least one common separating plate (40), wherein the first channel portion (20) and the second channel portion (30) comprise at least one channel portion outlet (24, 34) and at least one channel portion inlet (22, 32), respectively, and wherein the channel portion inlet (22, 32) of both channel portions (20, 30) are assembled spaced apart transversely to the conveyance direction F of the film web (200).

The present invention relates to a suction channel for a suction device for conveying of cut, particularly endless, waste strips of a film web and a suction device with a corresponding suction channel.

Basically, it is known that during the production of film webs edge strips and/or central strips are cut. This serves to ensure exact measurements for the to be produced film. These waste strips which are also named as edge strips or central strips have to be separated within the machine. For this separation it is known that suction devices with suction channels are provided. Such a solution is for example shown in reference DE 10 2012 108 196 A1. In this reference it is described how single waste strips in form of edge strips and/or central strips are guided trough the suction device in a common suction channel. This common suction channel extends transversely to the conveyance direction of the film web and accordingly leads the sucked waste strips to the side. Subsequently, it is possible that the discharged waste strips are introduced into a separate recycling process. Thus, for example, in form of a chopper a regranulation can occur such that said waste strips are reguided into the production machine, particularly into the extrusion device. This leads to a reduced waste and a higher efficiency in the production facility.

Disadvantageously with the known solutions is, however, that no possibility exists to impinge multiple extrusion devices with explicit parts of waste strips. This is until now only extensively possible with separate pipes. Thus, it is for example desired that with the production of a film the single extrusion devices of the different layers of the film web are only impinged with different maximum parts of the regranulate from the chopped waste strips. Herefore, a corresponding separation has to be ensured which is not provided by known suction channels. Likewise, it is until now not possible to consider eventual material differences between the waste strips at the edge and waste strips in the centre (and to separate for the separate recycling steps.

It is the object of the present invention to at least partially avoid the previously described disadvantages. Particularly, it is the object of the present invention to ensure a separate usage of the single parts of the waste strips in a cost efficient and easy manner.

The previous object is solved by a suction channel with the features of claim 1 and a suction device with the features of claim 12. Further features and details of the invention result from the dependent claims, the description and the drawings. Thereby, features and details which are described in connection with the suction channel according to the invention, naturally also apply in connection with the suction device according to the invention and vice versa such that according to the disclosure of the single aspects of the invention it can always be reciprocally related to.

A suction channel according to the invention serves for a suction device for conveying of cut waste strips of a film web transversely to the conveyance direction of the film web. Herefore, the suction channel according to the invention comprises a first channel portion and a second channel portion separated from the first channel portion via a common separating plate. Thereby, the first channel portion and the second channel portion each comprise at least one channel portion outlet and at least one channel portion inlet. Further, the channel portion inlets of both channel portions are assembled with a distance from one another transversely to the conveyance direction of the film web.

A solution according to the invention for a suction channel involves an elevation of the complexity of the single channel portions. While known suction channels comprise one single channel, according to the invention now a separation of the channel in different channel portions is provided. These channel portions preferably end in channel portion outlets which all open at the same side, namely at an axial edge of the whole suction channel. However, a double sided opening can be intended within the scope of the present invention. This is the connection interface for the further conveyance to the corresponding recycling. In order to ensure that according to the invention the separation of single waste strips can occur from other waste strips, an explicit geometric assembly of the channel portion inlets is intended. Thus, a channel portion inlet is a possibility to suck in a waste strip in the suction channel. This can happen explicitly direct or indirect. Thus, a channel portion inlet can for example be configured as a suction nozzle or can be in a fluid communicating manner with a suction nozzle. Thereby, for each suction nozzle an own channel portion inlet can be intended. However, it can be an advantage when each channel portion only comprises one channel portion inlet which is in fluid communicating connection by a corresponding cover plate with two or even more suction nozzles like it is subsequently described.

By establishing a distance of the different channel portion inlets from one another transversely to the conveyance direction it can be ensured that at different positions transverse to the conveyance direction of the film web different resulting waste strips are sucked into different channel portions of the suction channel. With other words, the separation of the sucked material occurs already during the suction and during the introduction into the suction channel.

Like it results from the previous description now no active separation has to occur. Rather, the suction channel is already configured in a manner that the separation so to say occurs automatically by the geometric correlation by the assembly of the suction channel and particularly by the transverse distance of the single channel portion inlets. A subsequent conveyance can occur in a separated manner since each channel portion ends in a single channel portion outlet. Therewith, it is now possible to introduce the waste strips from each channel portion which are therein separated and sucked in a separated further processing. Thus, for example, two ore more different extrusion devices of a production machine can be equipped separately by the respective channel portion.

Naturally, also three or more different channel portions can be intended which comprise accordingly particular channel portion inlets and preferably also particular channel portion outlets. Therewith, it is possible to achieve an even more precise separation. Thus, it is, for example, pointed out that film webs do not necessarily have to comprise a continuous material layer configuration across the whole width. Thus, it can, for example, be an advantage when complex and elaborate and moreover non-recyclable films are cut in the centre of its main component. The edge portion which has to be provided for the exact dimension for a cutting is preferably configured from a simple and recyclable plastic material. In such a case, preferably both waste strips are introduced separately in the corresponding channel portions as edge strips and can in this manner be introduced directly to the recycling and the extrusion device of the production machine. The central strips which are sucked in a separate channel portion in form of waste strips can not be recycled, but are explicitly introduced to another usage or discharge. Like in this example, even with complex geometries and complex requirements with complex film webs, a reduction of the waste material and an increase of the recycling quote are achievable.

By the orientation transversely to the conveyance direction thereby an orientation has to be understood which can, for example, comprise 90° or mainly 90°. However, in mainly each extension transversely to the film web is sufficient, as long as a suction channel with the corresponding channel portion inlets reaches to all positions at which waste strips arise by cutting. This likewise shows the high flexibility and possibility of use of the suction channel according to the invention.

A suction channel according to the invention also comprises a plurality of advantages, thus, it is significantly smaller in its dimensions than a complex tube solution or pipe solution which has to be provided with single tubes or pipes corresponding single channels for separated waste strips. A reduction of the geometric extensions leads to improved space relations and moreover an improved access to the machine. Likewise, within the suction channel only flow technical installations or flow technical optimisations can occur. This was not possible with classic pipe solutions. Until now, the improvement of the flow within the suction channel thereby aims at achieving a possibly high volume stream with low static pressures. This leads to the fact that by optimised flow relations the probability of an adhesion of a waste strip within the channel portion is significantly reduced. By the space reduction of the whole system of the suction channel also sharp edges and angles can be avoided at the outer side such that the risk of injury is reduced. A further advantage is the reduction of a mounting effort. Thus, here, preassembly work or even the whole preassembly of the whole suction channel can occur. With the final mounting at the respective production machine only the assembly of the completed premounted suction channel occurs which can be closed via corresponding intersections in form of channel portion inlets and the channel portion outlets at the further machine components.

It can further be an advantage when with the suction channel according to the invention at least one of both channel portions comprises a flow cross section alterating from the channel portion inlet to the channel portion outlet, particularly increasing. Particularly, with embodiments with which at a channel portion inlet multiple suction nozzles are assembled like subsequently described or with the intention of two more channel portion inlets a variation of the flow cross sections can comprise advantages. Particularly, this variation of the flow cross section aims to an optimisation of the flow cross section within the respective channel portions. Thus, the reduction of the flow cross section at the beginning after the channel portion inlet leads to an increase of the flow velocity and therewith to a higher security in the conveyance of the waste strip. Via the course of the channel portion, now the flow cross section can be enlarged to a channel portion outlet, thus, the flow cross section basically is reduced. However, the force for conveying is increased from now on with further additionally introduced inlet strips. This is however only a possibility of an optimisation of the flow which can be ensured by an altered flow cross section. Likewise it is possible to achieve a possibly even flow velocity over the course by a broadening. By the addition of a further nozzle the volume stream can be increased within the channel. An increased channel cross section in this manner can counteract an increasing flow velocity.

A suction channel according to the previously described paragraph can be further established in a way that the alteration of the respective flow cross section occurs at least sectionally continuously or mainly continuously. Thereby it has to be understood that sharp edges are preferably avoided but smooth cross section transitions are provided. Particularly, the flow relations concerning a variation of the flow cross section by an alteration of the width of the flow cross section and/or the height of the flow cross section are provided. Particularly, by a continuous variation an avoidance of sharp edges is ensured which otherwise can lead to an influence of the flow in form of vortex shedding or stall.

According to the invention it is possible that an alteration of the flow cross section by the assembly of the separating plate can be realized. The flow geometry is exceeded in flow direction and the cross section is adjusted to the tapering air stream. Accordingly, the separating plate is inclined, meaning not horizontal, assembled in the suction channel. In comparison to a horizontal course parallel to the outer wall of the suction channel the separating plate comprises a corresponding slope within the course of the suction channel. Hereby, it is likewise possible to configure sections with different slopes. The separating plate thereby comprises a geometric form which sectionally influences or alters the flow cross section. Thereby, it is possible to configure the separating plate for example S-like, bended or arch-like, particularly, in flow direction. Thereby, the material thickness can be altered or cavities or chambers can be existent at the separating plate. Within the scope of the invention it is possible to subsequently alter the assembly of the separating plate and thus to react on different conditions with adjusted flow cross section. Herefore, the separating plate is at least partially moveably mounted within the suction channel and can be positioned manually or automatically. A significant advantage of the separating plate results from the resulting separate air volumes which result with the surrounding flow at the separating plate.

A further advantage can be achieved when with the suction channel according to the invention in at least one of the channel portions at least a streaming installation can be installed for the variation of the flow cross section. Thereby, it has to be understood that the standard components for the single channel portions and the whole suction channel can be provided. According to the actual suction situation the corresponding flow installations can ensure an adjustment of the flow behaviour within these channel portions. Thus, such component can, for example, ensure the continuous enlargement of the flow cross section over the course of the channel portion outlet. Such flow installations can be flexible and interchangeable but also rigid within the respective channel portions. Likewise, in this manner even a local adjustment of the flow relations within the channel portions can be provided.

It is a further advantage when with the suction channel according to the invention at least one of the channel portions inlets comprises a bearing device for the moveable bearing of a suction nozzle. Thereby it has to be understood that a suction nozzle bridges the last portion between the channel portion inlet and the position of the suction of the waste strip from the film web. Such a suction nozzle is also a channel-like structure which delivers the provided negative pressure from a blower directly to the film web and accordingly the waste strip to abutting. This suction nozzle conveys and guides the sucked waste strips into the channel portion inlet. In order to ensure higher flexibility of the installation of the suction nozzle according to the invention the bearing device can serve not only for a simple assembly and mounting of the suction nozzle, but rather for a moveable bearing. Thus, a movement and therewith a displacement of the suction nozzle in form of a bearing device can be provided particularly transversely or mainly transversely to the conveyance direction of the film web. This permits to adjust an already mounted and readily configured suction nozzle to a different width of the film web and different configurations and positions of the waste strips during the cutting of the film web. For example, an outer pipe or a housing-like structure at the suction channel can be intended which configures the corresponding bearing device. At the same time the bearing device can be configured in a way that a corresponding sealing during the mounting of the suction nozzle is ensured.

It is advantageous, when with the embodiment according to the previous paragraph the bearing device comprises at least one stop which ensures the complete overlap with the suction nozzle in this channel portion. Like already described, the main idea of the present invention is the separation of waste strips in different channel portions. For the bearing device with a moveable configuration for the suction nozzle the stop leads to the fact that despite of the displacement of the suction nozzle it is always ensured that the fluid communicating configuration of the suction nozzle always exists with the correct channel portion inlet.

Particularly, an overlap in the cut area with two neighbouring channel portion inlets is avoided with a high security.

A suction channel according to the invention can be further established in a way that at least at one of the channel portion inlets and/or at least in one of the channel portion outlets an adapter pipe for the fluid communicating connection with a further channel device is assembled. By an adapter pipe particularly a flange system has to be understood which particularly provides a variation of the corresponding flow cross sections. Thus, for example, such an adapter pipe can comprise tube or pipe fastening possibilities in order to introduce the provided waste strips at the respective channel portion outlet to a separate bearing device, a separate chopper or a separate blower. These are also according fluid communicating intersections which can be flexibly introduced in existing production facilities by the configuration of an adapter pipe.

It is further an advantage when with the suction channel according to the invention at least a third channel portion with a channel portion inlet is assembled in a way that it comprises a common channel portion outlet with a first channel portion. Like already described, for example, both lateral edges can be directly recycled as waste strips and can be redirected to the production process as single origin or mainly single origin plastics. With complex film layer configurations a central strip can often not be introduced in such a recycling step but has to be separately discharged or has to be introduced into another extruder. Likewise different cutting systems for different thicknesses of the different waste strips can be used. The correlation of an additional third channel portion permits at different and particularly separated positions of a film web to collect single origin waste strips and to provide it in a common channel portion outlet. This shows that by a suction channel according to the invention also complex recycling solutions in form of a merging of different positions can be solved in a simple and cost efficient manner.

The suction channel of the previous embodiment can be improved in a way that the third channel portion adjoins the second channel portion at an opposite side than the first channel portion. With other words, therewith the lateral stripes left and right of a film web can be separately sucked and merged in a common channel portion outlet. A corresponding central strip assembled and cut in the middle can be separately sucked into the second channel portion as a waste strip and is separately provided from the lateral strips at a respective channel portion outlet of the second channel portion. This further shows a high flexibility and an extensive possible application of a suction channel according to the invention.

Likewise, it can be an advantage when the channel portions of a suction channel according to the invention extend respectively over the whole or mainly the whole width of the suction channel. Thereby, particularly the main extension has to be understood such that in parts, particularly in the area of channel portion outlets, reductions in the width can be provided for corresponding merging solutions in common channel portion outlets. An extension over the whole width of the suction channel serves for the fact to provide the geometric measures of the suction channel, particularly completely as flow cross section. This naturally does not influence the possibility of flow influences via corresponding flow installations for the optimisation of the flow conveyance.

It can be another advantage when with the suction channel according to the invention the channel portion inlets comprise the same or mainly the same open direction and/or the channel portion outlets comprise the same or mainly the same open direction. By open direction the orientation of the corresponding cross section area concerning the surface normal of this opening has to be understood. An equal orientation reduces the complexity of the geometric assembly of a suction channel according to the invention. At the same time, a more compact construction is enabled. It is preferred when the opening direction of the channel portion inlet comprises another orientation than the open direction of the channel portion outlet. Particularly, the channel portion inlets are mainly assigned perpendicularly to the film web. The open directions of the channel portion outlet are preferably transverse, particularly perpendicular to the opening direction of the channel portion inlets such that a lateral perpendicular discharge of the separately sucked and provided waste strips is enabled.

A further subject matter of the present invention is a suction device for suction and conveyance of the cut waste strips of a film web. Such a suction device comprises a suction channel according to the invention and at least a suction nozzle for each channel portion inlet. Further, at least a blower for the production of an air stream within the suction channel and the suction nozzle is intended. Thereby, fluid communicating connections between the single components exist such that negative pressure systems provided by the blower can be provided at the other edge of the respective suction nozzle for sucking the corresponding waste strips. Additionally, a chop device can be intended in order to regranulate the sucked waste strips and to introduce these into a recycling process, for example, a recycling in the extrusion device with the production of a film web. Naturally, such a chopper can be combined with a blower in order to provide a corresponding simple and cost efficient solution with the use of a suction channel according to the invention. A suction device according to the invention comprises the same advantages like they are described in detail for the suction channel according to the invention.

Further advantages, features and details of the invention result from the subsequent description in which embodiments of the invention are described in detail in relation to the drawings. Thereby, the described features in the claims and in the description can be essential for the invention each respective for itself or in any combination. It is shown schematically:

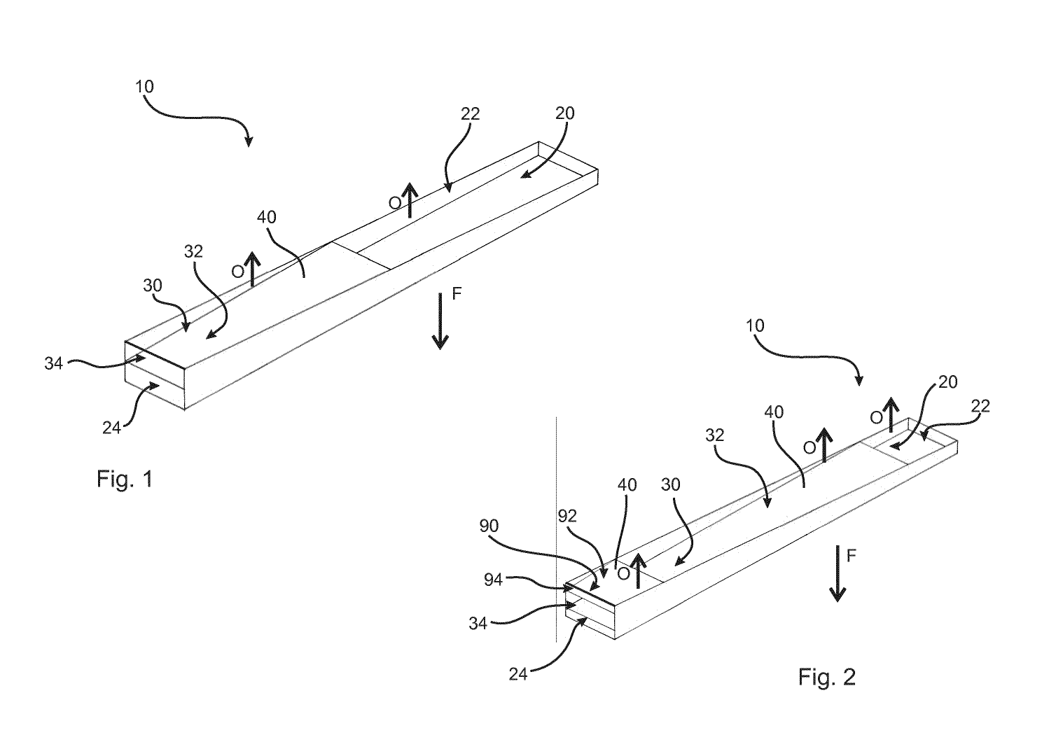

FIG. 1 a first embodiment of a suction channel according to the invention,

FIG. 2 a further embodiment of a suction channel according to the invention,

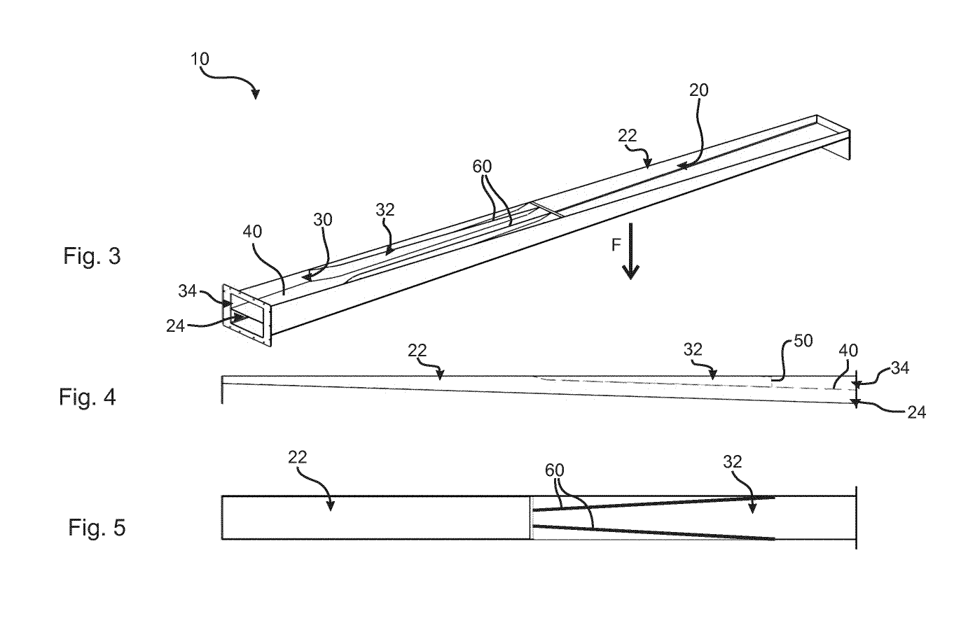

FIG. 3 a further embodiment of a suction channel according to the invention,

FIG. 4 an embodiment of FIG. 3 in a lateral representation,

FIG. 5 the embodiment of FIG. 3 and FIG. 4 in topview,

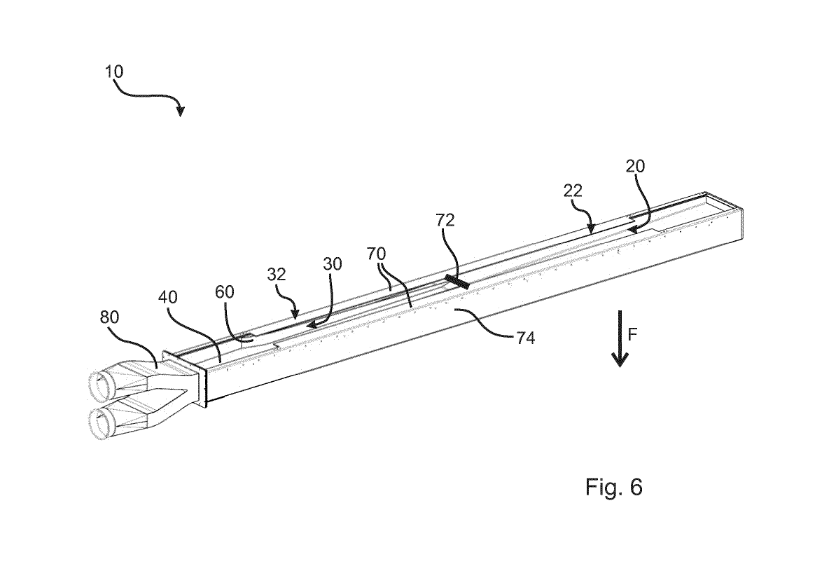

FIG. 6 a further embodiment of a suction channel according to the invention,

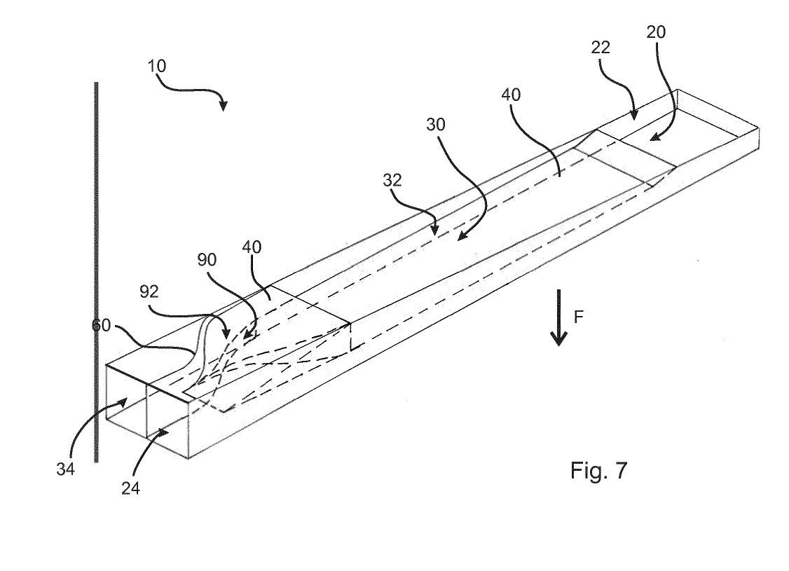

FIG. 7 a further embodiment of a suction channel according to the invention,

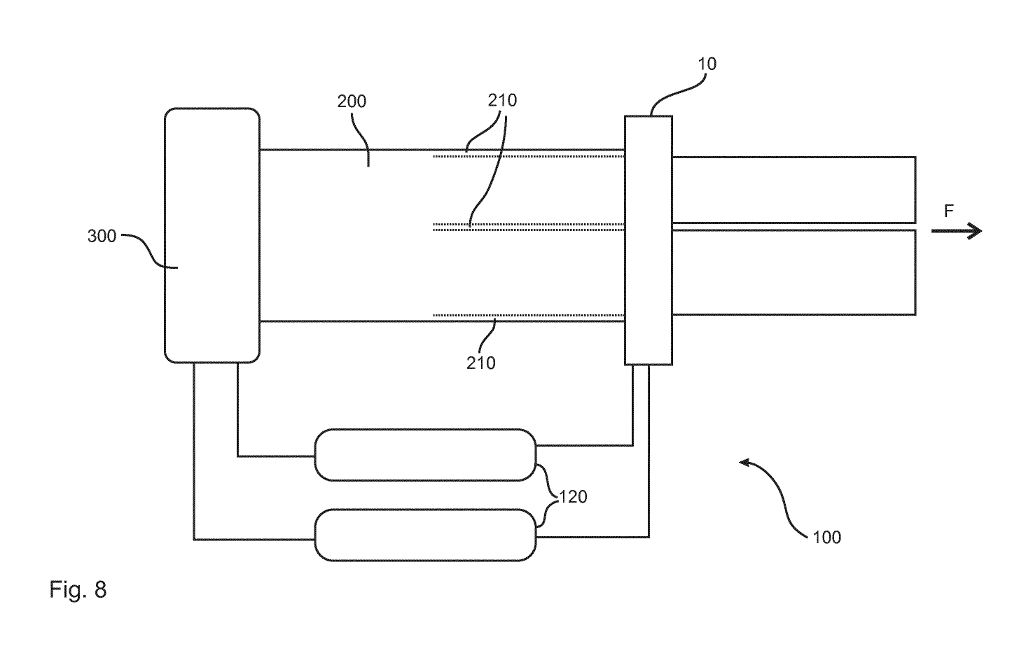

FIG. 8 an embodiment of a suction device according to the invention,

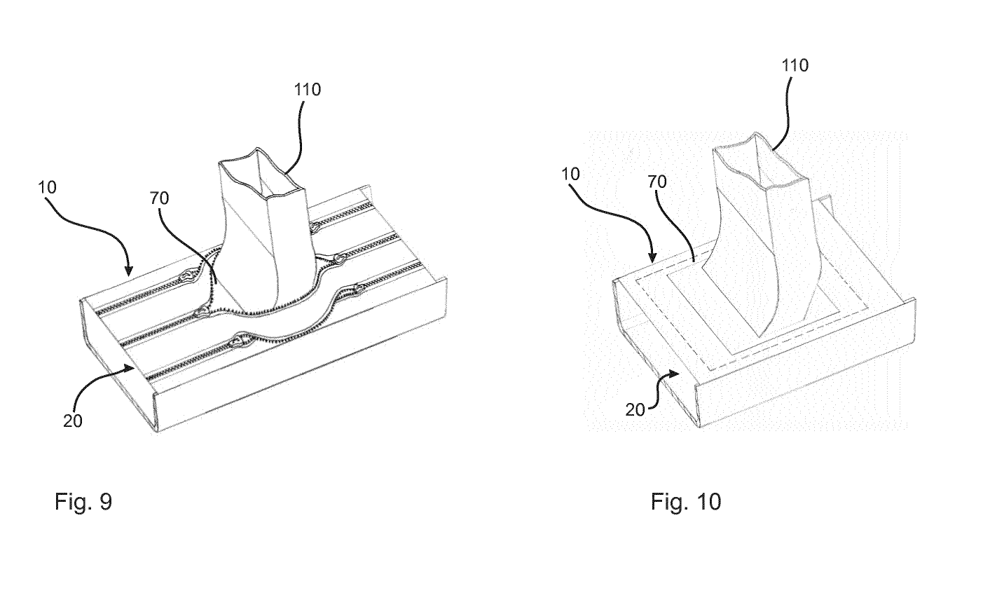

FIG. 9 an embodiment of a bearing device for a suction nozzle,

FIG. 10 a further embodiment of a bearing device for a suction nozzle,

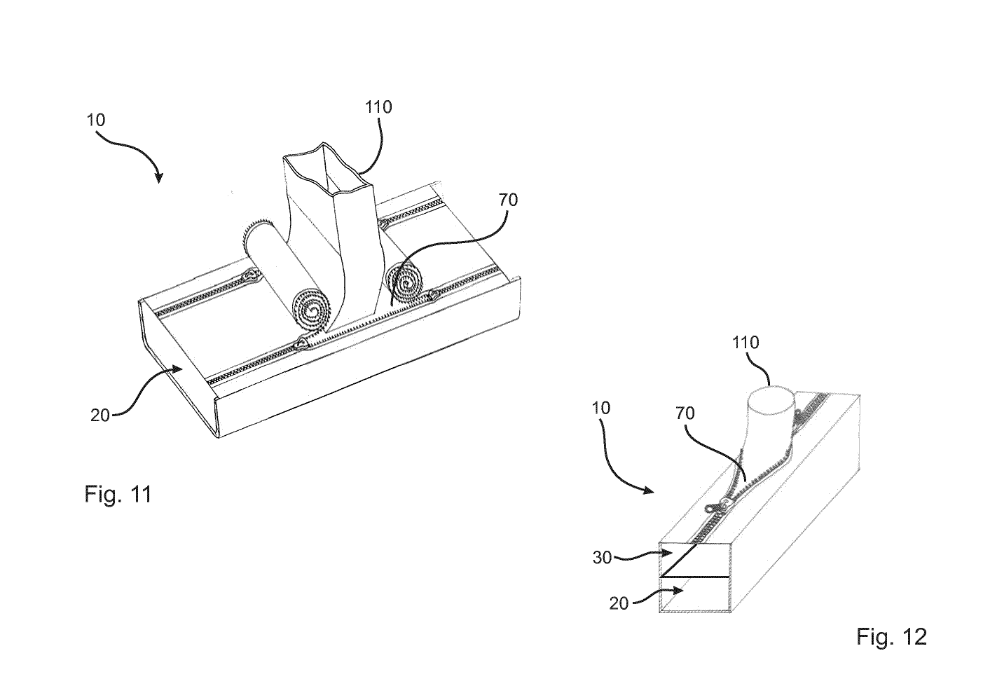

FIG. 11 a further embodiment of a bearing device for a suction nozzle,

FIG. 12 a further embodiment of a bearing device for a suction nozzle.

In FIG. 1 a schematic embodiment of a suction channel 10 according to the invention is shown. It can be recognized that a common separating plate 40 separates two separate channel portions 20 and 30 over the whole width of the suction channel 10 from one another. Each of these two channel portions 20 and 30 comprises a respective channel portion inlet 22 and 32. Via this channel portion inlet 22 and 32 which is here configured as a complete opening with an opening direction O upwards, one or multiple waste strips 210 of a film web 200 can be sucked in. These two channel portion inlets 22 and 32 are spaced apart from one another transversely to the shown conveyance direction F of the film web 200 such that differently positioned and cut waste strips 210 are sucked-in corresponding to their location and are guided separately in the respective channel portion 20 and 30. At the left lower edge these two channel portions 20 and 30 lead to corresponding channel portion outlets 24 and 34 such that there the sucked waste strips 210 are separated from one another in relation to the respective position channel portion inlet 22 and 32 provided through both channel portions 20 and 30. In the shown position the separating plate 40 is assembled inclined within the suction channel 10. Accordingly the flow cross section alters in the course of the channel portion 30 such that at the channel portion outlets 24, 34 different flow course sections are provided to the channel portion inlet 22, 32.

FIG. 2 shows an improvement of the embodiment of FIG. 1 wherein here a variation with in total three channel portions 20, 30 and 90 is shown. With this embodiment the third channel portion 90 is equipped with a respective channel portion inlet 92 and a respective channel portion outlet 94. The opening directions O of all channel portion inlets 22, 32 and 92 point in the same direction, namely, mainly perpendicularly upwards to the conveyance direction F. However, mainly an even orientation of the opening direction O and the conveyance direction F is possible. Likewise in FIG. 2 the length of the separating plate 40 can be recognized which comprises an inclined course along the suction channel 10. In comparison to the course shown in FIG. 1, the sections of the separating plates 40 within the suction channel 10 comprise different lengths wherein a corresponding flow profile within the channel portions 20, 30 and 90 is achievable.

FIGS. 3 to 5 show a further embodiment of a suction channel 10 according to the invention. This is equipped likewise with two separate channel portions 20 and 30 wherein respectively a single channel portion inlet 22 and 32 is directed upwards. Here, each channel portion 20 and 30 comprises an own channel portion outlet 24 and 34. In the second channel portion 30 flow applications 60 are intended which ensure a continuous or mainly continuous broadening of the flow cross section 50 (see FIG. 4) over the course of the channel portion outlet 34. This leads to an optimised flow within the second channel portion 30 such that an adhering situation for the waste strips 210 is avoided with a high probability. Further, in this way an even flow velocity with the use of multiple nozzles results. With this embodiment naturally a plurality of suction nozzles 110 can be assembled which are described later. These suction nozzles 110 can comprise different opening areas.

FIG. 6 shows the embodiment of FIG. 3 to FIG. 5 with an additionally assembled adaptor pipe 80. Here, the waste strips 210 provided separately can be further conveyed. It can be also recognized that an outer pipe 74 is intended which can configure a bearing device 70. At this bearing device 70 a plurality of suction nozzles 110 can be assembled which are particularly assembled axial transversely to the conveyance direction F in displaceable manner. This is later described according to FIGS. 9 to 12. It can be also recognized that a stop 72 ensures that despite the displacement bearing a suction nozzle 110 secures the correlation to the respective channel portion inlet 22 and 23.

FIG. 7 likewise shows a complex embodiment of the suction channel 10 according to the invention. Here, additionally a third channel portion 90 is intended which, however, provides via a corresponding cutting from its own channel portion inlet 92 the corresponding sucked waste strips 210 to a common channel portion outlet 24 with the first channel portion 20. This is particularly used when the lateral strips left and right as waste strips 210 separately from the middle strip as waste strips 210 are provided for the further discharge or the further recycling.

FIG. 8 shows a possibility of a suction device 100 according to the invention. This serves for ensuring by a production device 300 which produces film webs 200 a corresponding suction. The film web 200 is here cut into two film webs according to the production request such that a central strip as waste strip 210 and two edge strips as waste strips 210 result. The suction device 100 comprises a suction channel 10 which extends transversely to the conveyance direction F via the whole film web 200. By the separation by a suction channel 10 according to the invention subsequently at the lower edge the separately provided waste strips 210 via two channel portion outlets 24 and 34 can be provided for two separate blowers 120. Likewise a separate reguidance of the production device 300 is enabled.

In FIG. 9 a possibility of a bearing device 70 is shown which can act as a sealing device and ensures with a zipper system a dischargeable bearing and preferably a sealing of the suction nozzle 110 at the suction channel 10.

FIG. 10 shows a further solution of a bearing device 70 such that here overlapping areas ensure a corresponding moveable displacement of the suction nozzle 110 at the suction channel 10.

FIG. 11 likewise shows a zipper variation which ensures the corresponding sealing for the bearing device 70 and the suction nozzle 110.

FIG. 12 likewise shows a zipper variation with reduced complexity such that here the combination is shown by a second channel portion 30.

The previous description of the embodiments describes the present invention only within the scope of the examples. Naturally, single features of the embodiments as far as technically meaningful can be freely combined with one another without leaving the scope of the present invention.

### REFERENCE LIST

10 Suction channel
20 First channel portion
22 Channel portion input
24 Channel portion output
30 Second channel portion
32 Channel portion input
34 Channel portion output
40 Common separating plate
50 Flow cross section
60 Flow application
70 Bearing device
72 Stop
74 Outer pipe
80 Adaptor pipe
90 Third channel portion
92 Channel portion inlet
94 Channel portion outlet
100 Suction device
110 Suction nozzle
120 Blower
200 Film web
210 Waste strips
300 Production machine
F Conveyance direction
O Opening direction

1. Suction channel for a suction device for conveying of cut waste strips of a film web transverse to the conveyance direction of the film web comprising
a first channel portion and a second channel portion separated from the first channel portion by at least one common separating plate, wherein the first channel portion and the second channel portion comprise at least one channel portion outlet and at least one channel portion inlet, respectively, and wherein the channel portion inlet of both channel portions are assembled spaced apart transversely to the conveyance direction of the film web, wherein at least one of both channel portions comprises a flow cross section varying from the channel portion inlet to the channel portion outlet.

2. Suction channel according to claim 1,
wherein
at least one of both channel portions comprises an enlarging flow cross section from the channel portion inlet to the channel portion outlet.

3. Suction channel according to claim 2,
wherein
the alteration of the respective flow cross section occurs at least sectionally continuously or mainly continuously.

4. Suction channel according to claim 2,
wherein
in at least one of the channel portions at least one flow element is installed for the variation of the flow cross section.

5. Suction channel according to claim 1,
wherein
at least one of the channel portion inlets comprises a bearing device for the moveable bearing of a suction nozzle.

6. Suction channel according to claim 5,
wherein
the bearing device comprises at least one stop which ensures the complete overlapping of the suction nozzle with said channel portion inlet.

7. Suction channel according to claim 1,
wherein
at least at one of the channel portion inlets an adaptor pipe is assembled for the fluid communicating connection with a further channel device.

8. Suction channel according to claim 1,
wherein
at least a third channel portion is assembled with a channel portion inlet in a way that it comprises a common channel portion outlet with the first channel portion.

9. Suction channel according to claim 8,
wherein
the third channel portion adjoins the second channel portion on an opposing side as the first channel portion.

10. Suction channel according to claim 1,
wherein
the channel portions extend over the complete or mainly complete width of the suction channel respectively.

11. Suction channel according to claim 1,
wherein
at least the channel portion inlets comprise an even or mainly even opening direction or the channel portion outlets comprise an even or mainly even opening direction.

12. Suction device for suction and conveyance of cut waste strips of a film web, comprising a suction channel with the features of claim 1, at least a suction nozzle for each suction portion inlet and at least a blower for the production of an air stream within the suction channel and the suction nozzle.

13. Suction channel according to claim 1,
wherein
the separating plate is assembled inclined within the suction channel
wherein the flow cross section of the channel portion is altered.

14. Suction channel according to claim 1,
wherein
the separating plate is configured in a way that the separating plate is at least manually positionable or mechanically within the channel portion.

15. Suction channel according to claim 1,
wherein
the separating plate is at least configured S-like or bended or arch-like.

16. Suction channel according to claim 1,
wherein
at least at one of the channel portion outlets an adaptor pipe is assembled for the fluid communicating connection with a further channel device.
